(19) United States
(12) Patent Application Publication
(10) Pub. No.: US 2025/0336034 A1
(43) Pub. Date: Oct. 30, 2025

(54) IMAGE PROCESSING SYSTEM, IMAGE PROCESSING METHOD, AND TRAINING SYSTEM

(71) Applicant: REALTEK SEMICONDUCTOR CORP., Hsinchu (TW)

(72) Inventor: Kang-Yu Liu, Hsinchu (TW)

(73) Assignee: REALTEK SEMICONDUCTOR CORP., Hsinchu (TW)

(21) Appl. No.: 18/963,244

(22) Filed: Nov. 27, 2024

(30) Foreign Application Priority Data
Apr. 24, 2024 (TW) 113115329

(51) Int. Cl. G06T 3/4046; G06T 7/00

(52) U.S. Cl. CPC G06T 3/4046; G06T 7/0002; G06T 2207/20081; G06T 2207/20084; G06T 2207/20132; G06T 2207/30168

(57) ABSTRACT

An image processing system, an image processing method, and a training system are provided. The image processing method includes: receiving, by a preprocessing module in an image processing module, an image, and downsampling the image to obtain a downsampled tensor; processing, by a neural network module in the image processing module based on a plurality of first parameters, the downsampled tensor and generating an output tensor; upsampling, by an upsampling module in the image processing module, the output tensor to generate an upsampled tensor having same dimensions as the image; and performing, by an addition module, element-by-element addition on the upsampled tensor and the image to obtain an output image.

### CROSS-REFERENCE TO RELATED APPLICATION

This non-provisional application claims priority under 35 U.S.C. § 119(a) to patent application Ser. No. 11/311,5329 filed in Taiwan, R.O.C. on Apr. 24, 2024, the entire contents of which are hereby incorporated by reference.

### BACKGROUND

### Technical Field

The present invention relates to image processing technologies, and in particular, to an image processing technology using a neural network.

### Related Art

Due to the performance limitation of a real-time image processing chip, many products do not enable an artificial intelligence model (such as a CNN network) for processing when receiving a 4K or 8K film input.

### SUMMARY

In view of this, some embodiments of the present invention provide an image processing system, an image processing method, and a training system to alleviate a problem in the prior art.

Some embodiments of the present invention provide an image processing system, including an image processing module and an addition module. The image processing module includes a preprocessing module, a neural network module, and an upsampling module, where the preprocessing module is configured to receive an image and downsample the image to obtain a downsampled tensor, the neural network module is configured to process the downsampled tensor based on a plurality of first parameters and generate an output tensor, the upsampling module is configured to upsample the output tensor to generate an upsampled tensor having same dimensions as the image, and the addition module is configured to perform element-by-element addition on the upsampled tensor and the image to obtain an output image.

Some embodiments of the present invention provide an image processing method, including: receiving, by a preprocessing module in an image processing module, an image, and downsampling the image to obtain a downsampled tensor; processing, by a neural network module in the image processing module based on a plurality of first parameters, the downsampled tensor and generating an output tensor; upsampling, by an upsampling module in the image processing module, the output tensor to generate an upsampled tensor having same dimensions as the image; and performing, by an addition module, element-by-element addition on the upsampled tensor and the image to obtain an output image.

Some embodiments of the present invention provide a training system. The training system includes a processing module and a to-be-trained image processing module. The to-be-trained image processing module includes a preprocessing module, a neural network module, an upsampling module, and an addition module. The preprocessing module is configured to receive an input training image and downsample the input training image to obtain a downsampled tensor. The neural network module is configured to process the downsampled tensor based on a plurality of first training parameters and generate an output tensor. The upsampling module is configured to upsample the output tensor to generate an upsampled tensor having same dimensions as the input training image. The addition module is configured to perform element-by-element addition on the upsampled tensor and the input training image to obtain an output training image. The processing module is configured to train the to-be-trained image processing module by using a plurality of training images in a training set and a plurality of target images corresponding to the training images, to obtain a trained parameter value of each of a plurality of image processing training parameters of the to-be-trained image processing module, where the plurality of image processing training parameters include the plurality of first training parameters.

Some embodiments of the present invention provide a training system. The training system includes a processing module and a to-be-trained neural network module. The to-be-trained neural network module includes a cropping module and a neural network classification module. The cropping module is configured to receive an input training image and crop the input training image to obtain a plurality of cropped images. The neural network classification module includes a plurality of training parameters. The neural network classification module is configured to generate an image quality classification corresponding to the input training image based on the plurality of cropped images. The processing module is configured to train the to-be-trained neural network module by using a plurality of training images in a training set and an image quality classification label of each of the training images, to obtain a trained parameter value of each of the training parameters.

Based on the above, some embodiments of the present invention provide an image processing system, an image processing method, and a training system. In the image processing system, the image is downsampled by the preprocessing module, then processed at a low resolution, and finally added back to the original image. Therefore, input dimensions of the neural network module may be reduced. A reduction in the input dimensions of the neural network module may reduce an amount of computation, a buffer required by operation, and energy consumption of the neural network module at runtime, so that the neural network module may be designed as a neural network with a deep structure under the same operation resource to obtain a wider field of view. In addition, an image processing effect may be quickly obtained through the neural network by means of the parameter values trained by the neural network training system.

### BRIEF DESCRIPTION OF THE DRAWINGS

FIG. 1 is a block diagram of an image processing system according to some embodiments of the present invention.

FIG. 2 is an operation timing diagram of an image processing system according to some embodiments of the present invention.

FIG. 3A, FIG. 3B, and FIG. 3C are schematic diagrams of operation of pixel unshuffling according to some embodiments of the present invention.

FIG. 4 is a block diagram of an upsampling module according to some embodiments of the present invention.

FIG. 5 is a block diagram of an image processing system according to some embodiments of the present invention.

FIG. 6 is a block diagram of an upsampling module according to some embodiments of the present invention.

FIG. 7 is a schematic diagram of cropping according to some embodiments of the present invention.

FIG. 8 is a block diagram of a neural network module according to some embodiments of the present invention.

FIG. 9 is a schematic diagram of a residual network layer according to some embodiments of the present invention.

FIG. 10 is a block diagram of a training system according to some embodiments of the present invention.

FIG. 11 is a block diagram of a training system according to some embodiments of the present invention.

FIG. 12 is a schematic block diagram of an electronic device system according to some embodiments of the present invention.

FIG. 13 is a flowchart of an image processing method according to some embodiments of the present invention.

FIG. 14 is a flowchart of an image processing method according to some embodiments of the present invention.

FIG. 15 is a flowchart of an image processing method according to some embodiments of the present invention.

FIG. 16 is a flowchart of an image processing method according to some embodiments of the present invention.

FIG. 17 is a flowchart of an image processing method according to some embodiments of the present invention.

### DETAILED DESCRIPTION

The foregoing and other technical contents, features, and effects of the present invention are to be clearly presented in the following detailed description of embodiments with reference to the accompanying drawings. Any modification and change that does not affect the efficacy and the purpose of the present invention shall still fall within the scope covered by the technical content disclosed in the present invention. The same reference numerals are used to indicate the same or similar elements in all of the drawings. A term “connection” mentioned in the following embodiments may refer to any direct or indirect and wired or wireless connection means. Terms with similar to ordinal numbers such as “first” or “second” described herein are used to distinguish or refer to associated same or similar elements or structures, and do not necessarily imply an order of such elements in a system. It is to be understood that in some cases or configurations, the ordinal numbers may be used interchangeably without affecting implementation of the present invention.

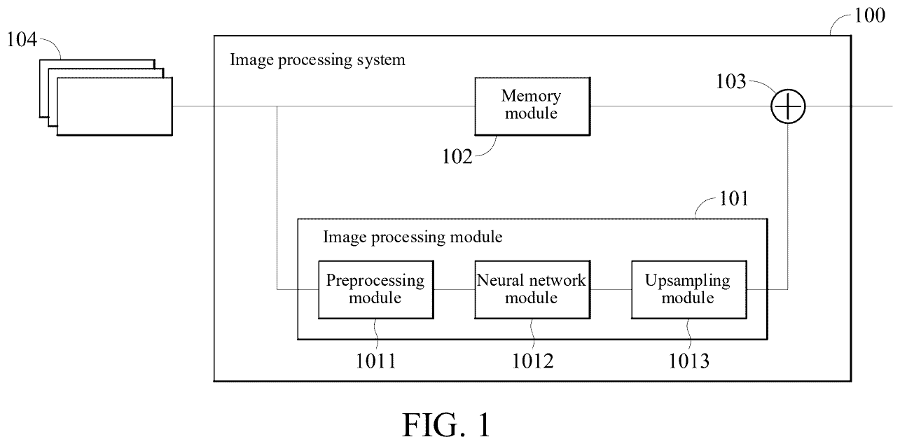

FIG. 1 is a block diagram of an image processing system according to some embodiments of the present invention. Referring to FIG. 1, an image processing system 100 includes an image processing module 101, a memory module 102, and an addition module 103. The image processing module 101 and the memory module 102 are configured to respectively receive a duplicate image of an image 104. The image processing module 101 is configured to process the duplicate image of the image 104. The memory module 102 is configured to temporarily store the duplicate image of the image 104 when the image processing module 101 processes the duplicate image of the image 104. The memory module 102 is, for example, a static random-access memory (SRAM) or a dynamic random-access memory (DRAM).

The image processing module 101 includes a preprocessing module 1011, a neural network module 1012, and an upsampling module 1013. The preprocessing module 1011 is configured to receive the duplicate image of the image 104 and downsample the duplicate image of the image 104 to generate a downsampled tensor of the image 104. The neural network module 1012 includes a neural network. The neural network module 1012 includes a plurality of parameters, where the parameters of the neural network module 1012 include a plurality of weights of the neural network of the neural network module 1012. For convenience of description below, the plurality of parameters of the neural network module 1012 are referred to as first parameters. The neural network module 1012 is configured to process a received tensor based on the plurality of first parameters and generate an output tensor. In the following description, an architecture of the neural network module 1012 is to be further described.

The upsampling module 1013 is configured to upsample the output tensor to generate an upsampled tensor having same dimensions as the image 104. The addition module 103 is configured to perform element-by-element addition on the received two tensors.

The image processing method of some embodiments of the present invention and how the modules of the image processing system 100 cooperate with each other are described in detail below with reference to the drawings.

FIG. 13 is a flowchart of an image processing method according to some embodiments of the present invention. Referring to FIG. 1 and FIG. 13 together, the image processing method includes steps S1301-S1304. In step S1301, a preprocessing module 1011 of an image processing module 101 receives a duplicate image of an image 104, and downsamples the duplicate image of the image 104 to generate a downsampled tensor. In step S1302, a neural network module 1012 of the image processing module 101 processes the downsampled tensor based on a plurality of first parameters of the neural network module 1012 and generates an output tensor. In step S1303, an upsampling module 1013 of the image processing module 101 upsamples the output tensor of the neural network module 1012 to generate an upsampled tensor having same dimensions as the image 104. In step S1304, an addition module 103 performs element-by-element addition on the upsampled tensor and the duplicate image of the image 104 stored in a memory module 102 to obtain an output image.

In some embodiments of the present invention, the image 104 is a high-resolution image. For example, the image 104 is a 4K or 8K image.

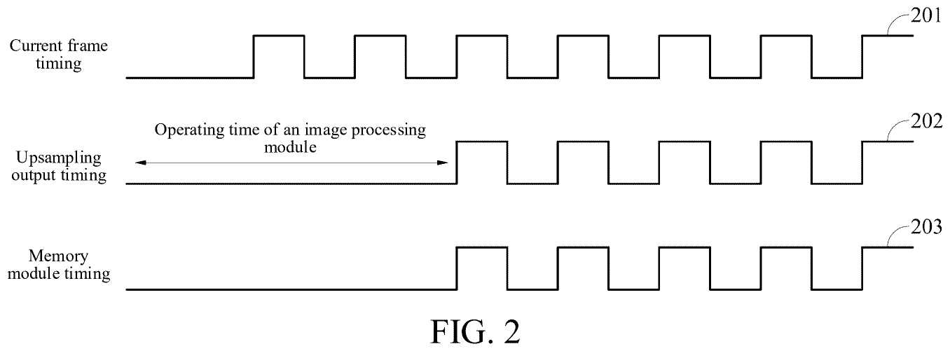

FIG. 2 is an operation timing diagram of an image processing system according to some embodiments of the present invention. Referring to FIG. 1, FIG. 2, and FIG. 13 together, in some embodiments of the present invention, the image processing system 100 is configured to process a frame in a film. In other words, the foregoing image 104 is a frame in the film. As shown in FIG. 2, the frame in the film is loaded into the image processing system 100 for processing based on a current frame timing 201. Since the image processing module 101 needs processing time to perform processing a plurality of times to capture important information, after the image processing system 100 loads a current frame as the image 104, the upsampling module 1013 outputs an upsampled tensor only after an operating time of the image processing module has passed (as shown in an output upsampling timing 202). In this case, as shown in a memory module timing 203 of a memory module 102 in FIG. 2, the memory module 102 starts to operate to output an original duplicate image of the stored image 104 to an addition module 103.

In the foregoing embodiments, the image 104 is downsampled by the preprocessing module 1011, then processed at a low resolution, and finally added back to the original image. Therefore, input dimensions of the neural network module 1012 may be reduced. A reduction in the input dimensions of the neural network module 1012 may reduce an amount of computation, a buffer required by operation, and energy consumption of the neural network module 1012 at runtime, so that the neural network module 1012 may be designed as a neural network with a deep structure under the same operation resource to obtain a wider field of view. Even if the memory module 102 is needed to store the original image 104 in the foregoing embodiment, resources that need to be used are reduced as a whole compared with a case in which the image 104 is directly processed.

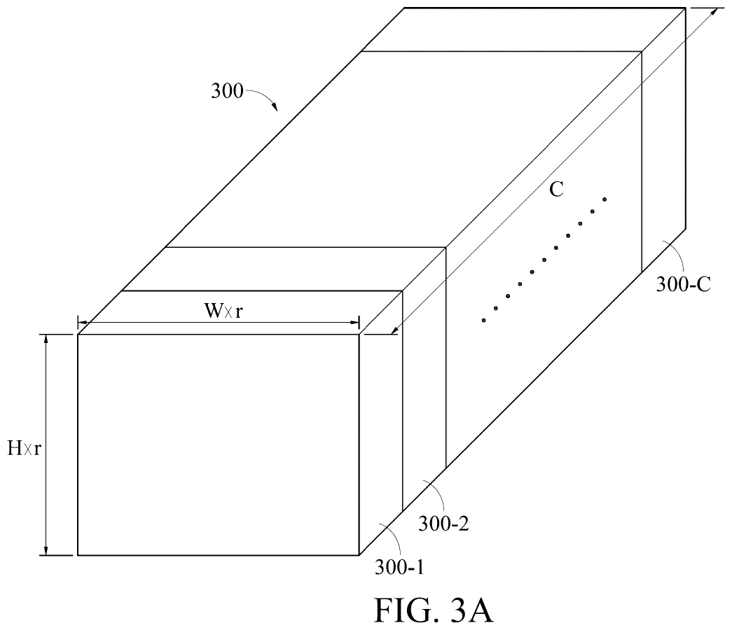

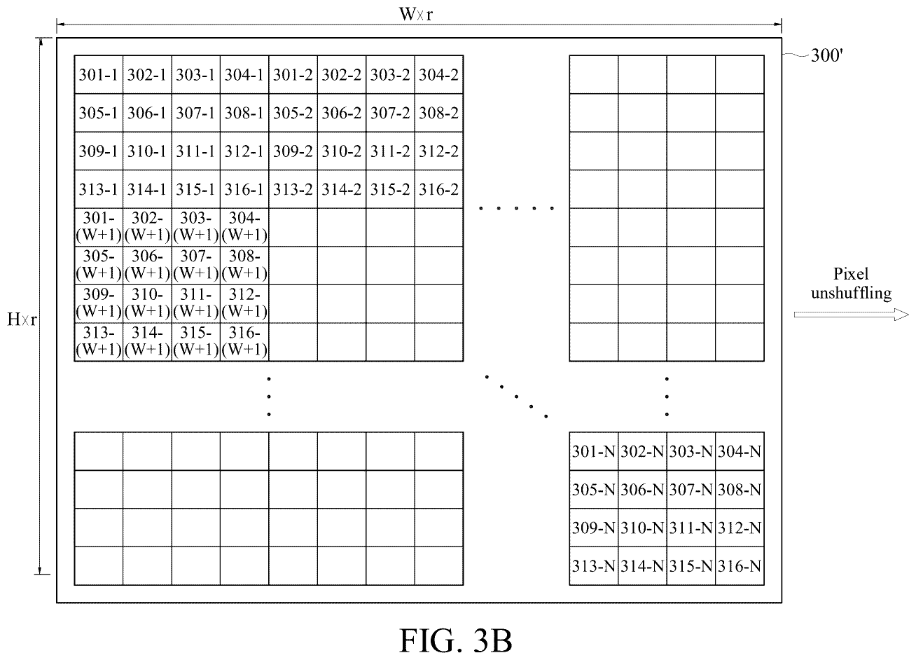

FIG. 3A, FIG. 3B, and FIG. 3C are schematic diagrams of operation of pixel unshuffling according to some embodiments of the present invention. Referring to FIG. 3A, FIG. 3B, and FIG. 3C together, a tensor 300 is a tensor with 3 axes, and a shape of the tensor is (H×r, W×r, C), where r=4, and H, W, and C are positive integers. In other words, the tensor 300 has H×r elements on a 0^{th} axis, W×r elements on a 1^{st} axis, and C elements on a 2^{nd} axis. The 2^{nd} axis of the tensor 300 is referred to as a channel axis of the tensor 300. The operation of performing pixel unshuffling on the tensor 300 is as follows. Based on a zoom-out factor r, for each of elements 300-1 to 300-C on the channel axis of the tensor 300, elements spaced apart from each other at an interval of r on the 0^{th} axis and the 1^{st} axis are combined to form a new channel element to transform the tensor 300 into a tensor with 3 axes in the shape of (H, W, C×r²).

The zoom-out factor r=4 is used for description. Referring to FIG. 3B and FIG. 3C together, a tensor 300′ is an element of the tensor 300 on the channel axis of the tensor 300. In FIG. 3B and FIG. 3C, elements 30k-1 to 30k-N on a 0^{th} axis and a 1^{st} axis of the tensor 300′ are the elements spaced apart from each other at the interval of r on the 0^{th}axis and the 1^{st} axis, where k=1, 2, . . . , and 16, and N=H×W. Therefore, the elements 30k-1 to 30k-N are combined to form a new channel element 30k (as shown in FIG. 3C), where k=1, 2, . . . , and 16. It is to be noted that, since the element content of the tensor 300 is not actually changed when pixel unshuffling is performed, when the tensor 300 is an image, pixel information of the tensor 300 is retained by performing pixel unshuffling on the tensor 300 based on the zoom-out factor r, where the pixel information of the image is information included by each pixel of the image, for example, an RGB value of a pixel.

In addition, it is to be noted that pixel shuffling performed on a 3-axis tensor based on the zoom-in factor r is a reversed operation of the above pixel unshuffling.

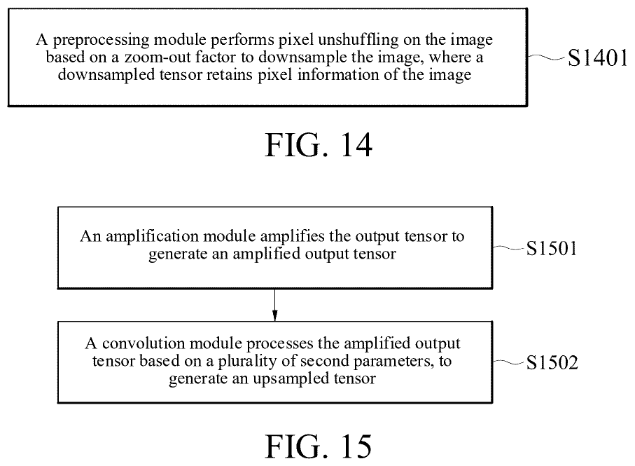

FIG. 14 is a flowchart of an image processing method according to some embodiments of the present invention. Referring to FIG. 1, FIG. 13, and FIG. 14 together, in some embodiments of the present invention, step S1301 includes step S1401. In step S1401, the preprocessing module 1011 performs pixel unshuffling on the duplicate image of the image 104 based on a zoom-out factor (for example, the foregoing zoom-out factor r) to downsample the image 104 and generate a downsampled tensor, where the downsampled tensor retains pixel information of the image 104.

In this embodiment, the pixel unshuffling is performed to downsample the image 104, so that the input dimensions of the neural network module 1012 may be reduced without losing pixel information, and the neural network module 1012 may receive complete pixel information of the image 104. The foregoing zoom-out factor r=4 is used as an example. If the image 104 is an 8K image (having dimensions of 7680×4320), the dimensions are 1960×1080×16 after pixel unshuffling based on the zoom-out factor 4. Therefore, a neural network having small input dimensions may be used.

Certainly, the preprocessing module 1011 may also downsample the duplicate image of the image 104 based on another downsampling method, for example, by deleting elements using a deletion method or using a pooling layer and a convolutional layer, to generate a downsampled tensor.

In some embodiments of the present invention, dimensions of the output tensor of the neural network module 1012 is set to be the same as that of the downsampled tensor generated by the preprocessing module 1011. The upsampling module 1013 is configured to perform pixel shuffling on the output tensor based on a zoom-in factor to upsample the output tensor, where the foregoing zoom-in factor is the same as the zoom-out factor of the preprocessing module 1011.

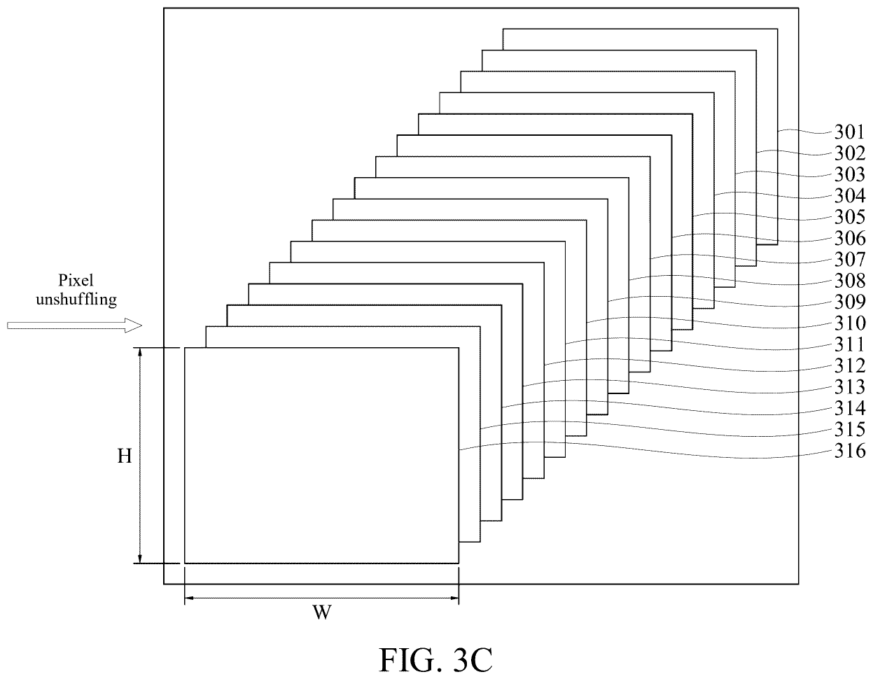

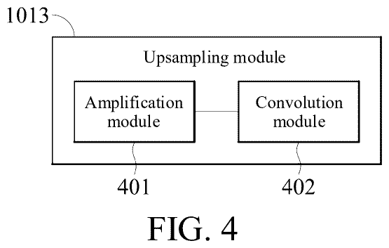

FIG. 4 is a block diagram of an upsampling module according to some embodiments of the present invention. FIG. 15 is a flowchart of an image processing method according to some embodiments of the present invention. Referring to FIG. 4, FIG. 13, and FIG. 15 together, in this embodiment, the upsampling module 1013 includes an amplification module 401 and a convolution module 402. The amplification module 401 is configured to amplify the output tensor to generate an amplified output tensor. The convolution module 402 includes at least one convolutional layer and has a plurality of parameters. A plurality of parameters of the foregoing convolution module 402 include weights of the convolutional layer. For convenience of description below, the plurality of parameters of the convolution module 402 are referred to as second parameters. The convolution module 402 is configured to process the amplified output tensor based on a plurality of second parameters to generate the upsampled tensor. The amplification module 401 may amplify the output tensor based on any amplification method. The foregoing amplification method is, for example, interpolation or 0-padding, which is not limited in the present invention.

In this embodiment, the foregoing step S1303 includes step S1501 and step S1502. In step S1501, the amplification module 401 amplifies the output tensor to generate the amplified output tensor. In step S1502, the convolution module 402 processes the amplified output tensor based on the foregoing plurality of second parameters, to generate the upsampled tensor.

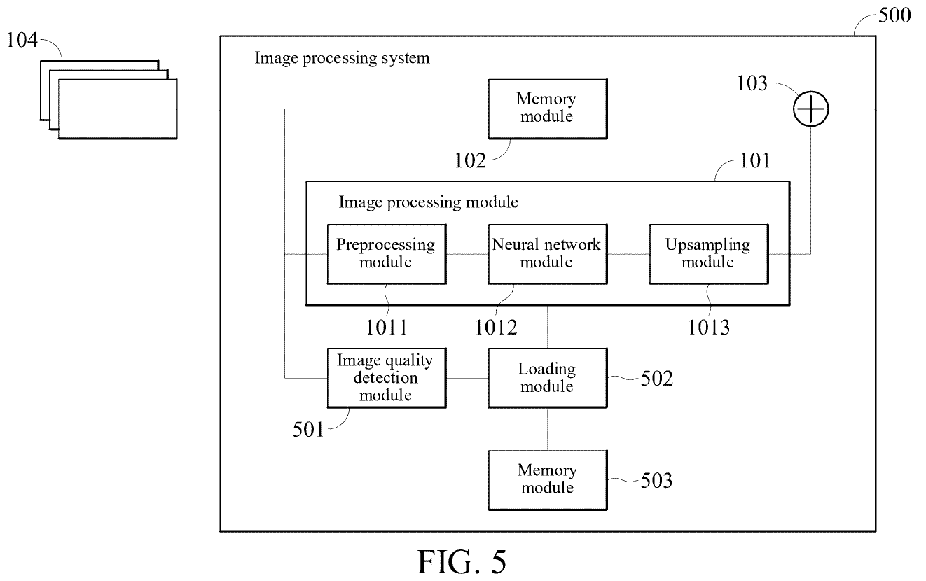

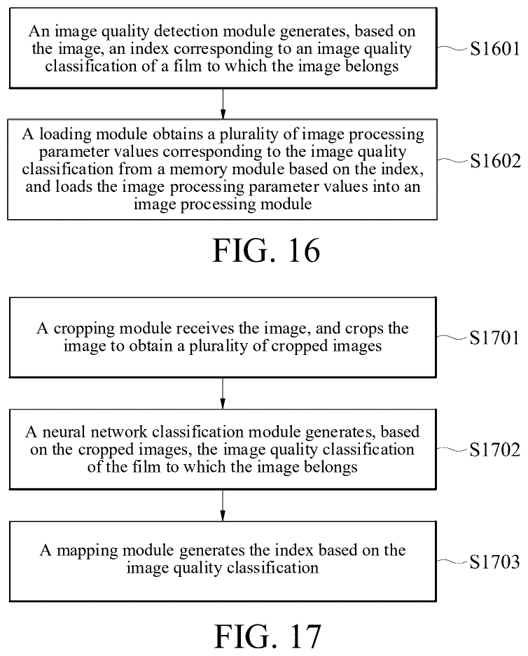

FIG. 5 is a block diagram of an image processing system according to some embodiments of the present invention. FIG. 16 is a flowchart of an image processing method according to some embodiments of the present invention. Referring to FIG. 5 first, compared with the image processing system 100, an image processing system 500 further includes an image quality detection module 501, a loading module 502, and a memory module 503. In this embodiment, an image 104 is a frame of a film. The image quality detection module 501 is configured to receive a duplicate image of the image 104 and generate, based on the duplicate image of the image 104, an index corresponding to an image quality classification of the film to which the image 104 belongs. The memory module 503, for example, may adopt a double data rate synchronous dynamic random access memory (DDR SDRAM) to increase an access speed.

The image quality classification of the foregoing film may include a compression rate and image quality of the film content. For example, the image quality classification of the film is recorded in the following table (I), including an 8K high bit rate, an 8K low bit rate, . . . , and a 2K low bit rate. Each image quality classification corresponds to an index. For example, the index of the 8K high bit rate is 0, and the index of the 8K low bit rate is 1.

TABLE I

| Index | 0 | 1 | 2 | 3 | 4 | 5 |
|---|---|---|---|---|---|---|
| Image quality | 8K high bit | 8K low bit | 4K high | 4K low | 2K high | 2K low |
| classification | rate | rate | bit rate | bit rate | bit rate | bit rate |

The loading module 502 is configured to obtain a plurality of image processing parameter values corresponding to the image quality classification from the memory module 503 based on the index corresponding to the image quality classification of the film to which the image 104 belongs, and load the obtained image processing parameter values into the image processing module 101.

The image processing parameter values include parameters required for the operation of the image processing module 101. For example, when the upsampling module 1013 adopts the architecture shown in the foregoing embodiment of FIG. 4, the image processing parameter values include parameter values of the plurality of first parameters of the neural network module 1012 and the plurality of second parameters of the convolution module 402.

Referring to FIG. 5 and FIG. 16 together, in this embodiment, the image processing method includes step S1601 to step S1602. In step S1601, the image quality detection module 501 generates, based on the duplicate image of the image 104, the index corresponding to the image quality classification of the film to which the image 104 belongs. In step S1602, the loading module 502 obtains the plurality of image processing parameter values corresponding to the image quality classification from the memory module 503 based on the index corresponding to the image quality classification of the film to which the image 104 belongs, and loads the image processing parameter values into the image processing module 101.

It is to be noted that the index corresponding to the image quality classification of the film to which the image 104 belongs is set to enable the loading module 502 to quickly find the plurality of image processing parameter values corresponding to the image quality classification from the memory module 503, and may be set arbitrarily, which is not limited to the embodiment recorded in Table (I). For example, a numerical value 0 may also be used as an index of the 2K low bit rate.

In the foregoing embodiment, since the mechanism of switching the parameters of the image processing module 101 based on the image quality classification of the film to which the image 104 belongs is adopted, different parameters may be adopted for different kinds of films to achieve a better processing effect. Different processing effects may also be generated for different kinds of films based on requirements.

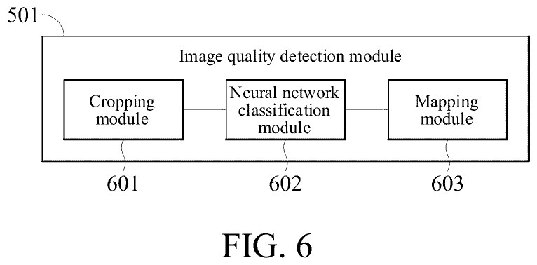

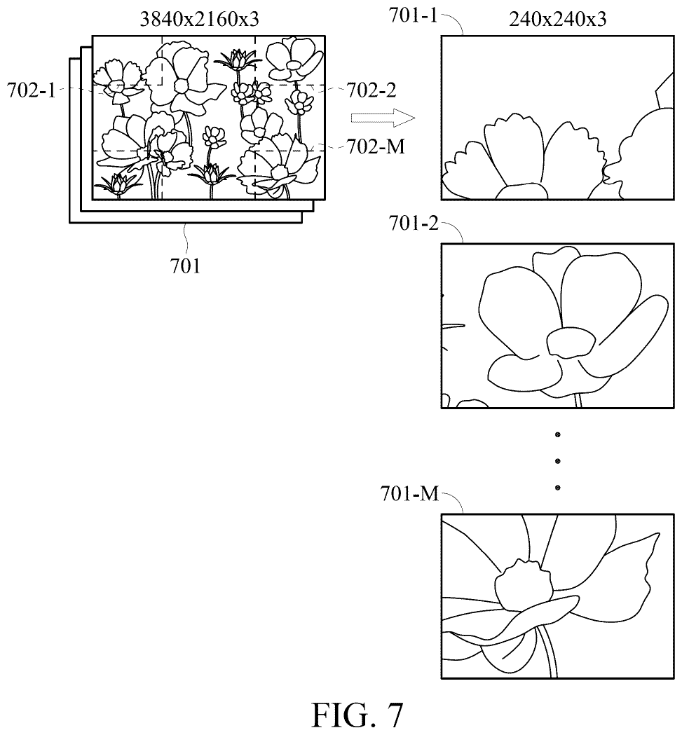

FIG. 6 is a block diagram of an upsampling module according to some embodiments of the present invention. FIG. 7 is a schematic diagram of cropping according to some embodiments of the present invention. Referring to FIG. 6, an image quality detection module 501 includes a cropping module 601, a neural network classification module 602, and a mapping module 603. The cropping module 601 is configured to receive a duplicate image of an image 104 and crop the duplicate image of the image 104 to obtain a plurality of cropped images. The cropping positions of the foregoing cropping may be a plurality of fixed positions or a plurality of random positions.

Referring to FIG. 7, in some embodiments of the present invention, the duplicate image of the image 104 is an image 701, and the cropping module 601 crops the image 701 to obtain the cropped images 701-1 to 701-M based on the fixed positions 702-1 to 702-M, where dimensions of the image 701 are 3840×2160×3, dimensions of the cropped images 701-1 to 701-M are 240×240×3, and M is a positive integer. Certainly, the cropping module 601 may also crop the image 701 to obtain the cropped image based on another fixed position, or randomly select a fixed number of positions from the positions 702-1 to 702-M to crop the image 701 to obtain the cropped image.

The neural network classification module 602 is configured to receive the foregoing plurality of cropped images, and generate, based on the received cropped images, the image quality classification of the film to which the image 104 belongs. In some embodiments of the present invention, the neural network classification module 602 includes a convolutional layer, a fully connected layer, and a normalized exponential function layer (softmax layer). The convolutional layer of the neural network classification module 602 is configured to capture features of the foregoing plurality of cropped images, the fully connected layer is configured to integrate the features of the foregoing plurality of cropped images to generate a plurality of outputs, and the normalized exponential function layer is configured to receive the outputs of the fully connected layer and output a corresponding probability that the film to which the image 104 belongs falls into each image quality classification. For example, the image quality classification is recorded in Table (I). The normalized exponential function layer is set to include 6 outputs, where the first output is a probability that the film has the 8K high bit rate, the second output is a probability that the film has the 8K low bit rate, and so on.

The mapping module 603 is configured to generate the index based on the image quality classification. For example, the mapping module 603 selects the image quality classification with the highest probability based on the output of the normalized exponential function layer, and outputs the index corresponding to the image quality classification with the highest probability. For example, the mapping module 603 determines, based on the output of the normalized exponential function layer, that the image quality classification with the highest probability is the 8K high bit rate, and the mapping module 603 generates an index of 0.

FIG. 17 is a flowchart of an image processing method according to some embodiments of the present invention. Refer to FIG. 6, FIG. 7, and FIG. 17 together. In this embodiment, the foregoing step S1601 includes step S1701 to step S1703. In step S1701, a cropping module 601 receives a duplicate image of an image 104 and crops the duplicate image of the image 104 to obtain a plurality of cropped images. In step S1702, a neural network classification module 602 generates, based on the foregoing plurality of cropped images, an image quality classification of a film to which the image 104 belongs. In step S1703, the mapping module 603 generates an index based on the image quality classification of the image 104.

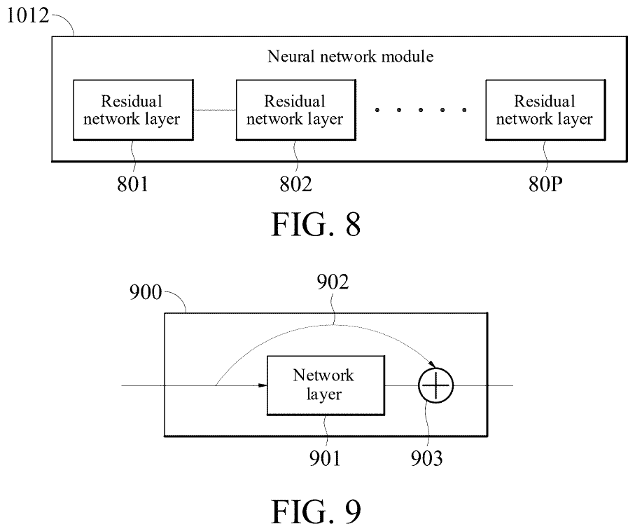

FIG. 8 is a block diagram of a neural network module according to some embodiments of the present invention. FIG. 9 is a schematic diagram of a residual network layer according to some embodiments of the present invention. Refer to FIG. 8 and FIG. 9. A neural network module 1012 includes residual network layers 801-80P connected in series, where P is a positive integer. The residual network layers 801-80P are configured to receive a downsampled tensor generated by a preprocessing module 1011 and process the downsampled tensor to generate an output tensor. An architecture of each of the residual network layers 801-80P is as shown in a residual network layer 900. The residual network layer 900 includes a network layer 901, an addition module 903, and a path 902 directly connected to the addition module 903 through an input of the network layer 901. The network layer 901 includes a neural network. It is to be noted that the neural network of the network layer 901 of each of the residual network layers 801-80P may be the same or different, which is not limited in the present invention. In this embodiment, the foregoing step S1302 includes receiving the downsampled tensor and generating the output tensor by the residual network layers 801-80P.

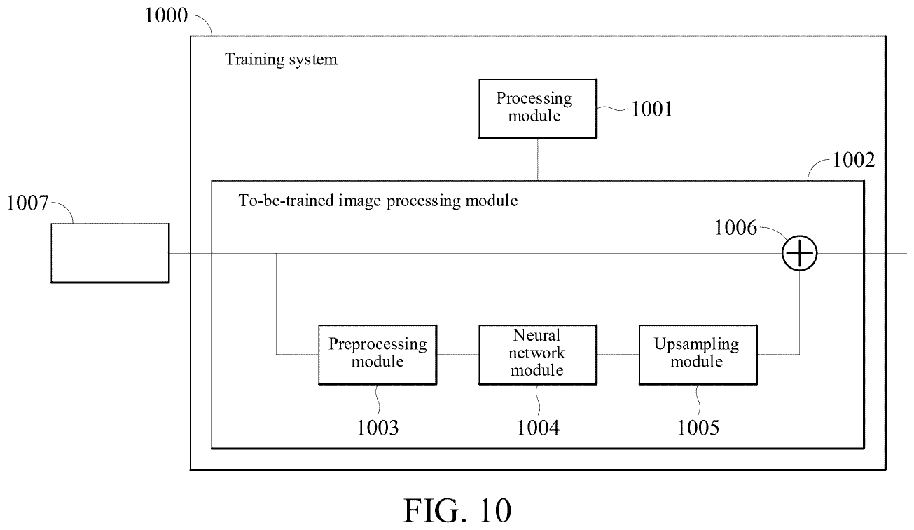

FIG. 10 is a block diagram of a training system according to some embodiments of the present invention. Refer to FIG. 10. A training system 1000 includes a processing module 1001 and a to-be-trained image processing module 1002. The to-be-trained image processing module 1002 includes a preprocessing module 1003, a neural network module 1004, an upsampling module 1005, and an addition module 1006. The preprocessing module 1003 is configured to receive a duplicate image of an input training image 1007 and downsample the duplicate image of the input training image 1007 to obtain a downsampled tensor. The neural network module 1004 includes a plurality of first training parameters. The neural network module 1004 is configured to process the downsampled tensor based on the foregoing plurality of first training parameters and generate an output tensor. The upsampling module 1005 is configured to upsample the output tensor to generate an upsampled tensor having same dimensions as the input training image. The addition module 1006 is configured to perform element-by-element addition on the upsampled tensor and the image to obtain an output training image. Implementations of the preprocessing module 1003, the neural network module 1004, the upsampling module 1005, and the addition module 1006 are the same as those of the preprocessing module 1011, the neural network module 1012, the upsampling module 1013, and the addition module 103. Therefore, regarding the various embodiments of the preprocessing module 1003, the neural network module 1004, the upsampling module 1005, and the addition module 1006, reference may be made to the related embodiments of the preprocessing module 1011, the neural network module 1012, the upsampling module 1013, and the addition module 103.

The processing module 1001 is configured to input, by using a plurality of training images in a training set and a plurality of target images corresponding to the training images, each of the foregoing plurality of training images as an input training image 1007 to the to-be-trained image processing module 1002 to train the to-be-trained image processing module 1002. Upon completion of the training, the processing module 1001 may obtain a trained parameter value of each of a plurality of image processing training parameters of the to-be-trained image processing module 1002. The foregoing image processing training parameters include the foregoing first training parameters.

In some embodiments of the present invention, a user collects a plurality of sets of training sets for different image quality classifications (for example, the image quality classifications recorded in Table (I) above) and effects (for example, noise reduction, sharpening, or adding details) to be produced by the image processing system 100 after processing the image 104. The training system 1000 trains the to-be-trained image processing module 1002 based on these training sets to obtain the trained parameter values of different sets of image processing training parameters. The training system 1000 then stores the trained parameter values of these different sets of image processing training parameters into the foregoing memory module 503 based on the image quality classifications, so that the loading module 502 is configured to retrieve and use the trained parameter values based on the index corresponding to the image quality classification of the film to which the image 104 belongs.

In some embodiments of the present invention, the upsampling module 1005 is configured to perform pixel shuffling on the output tensor based on a zoom-in factor, to upsample the output tensor outputted by the neural network module 1004.

In some embodiments of the present invention, the upsampling module 1005 is the same as the upsampling module 1013 recorded in FIG. 4, and includes an amplification module and a convolution module. The amplification module of the upsampling module 1005 is configured to amplify the output tensor of the neural network module 1004 to generate an amplified output tensor. The convolution module of the upsampling module 1005 includes at least one convolutional layer and has a plurality of parameters, and the plurality of parameters of the convolution module of the foregoing upsampling module 1005 include weights of the convolutional layer. For convenience of description, the plurality of parameters of the convolution module of the upsampling module 1005 are referred to as second training parameters. The convolution module of the upsampling module 1005 is configured to process the amplified output tensor based on the foregoing plurality of second training parameters to generate an upsampled tensor. Implementations of the amplification module and the convolution module of the upsampling module 1005 are the same as those of the amplification module 401 and the convolution module 402 described above. Therefore, for the implementations of the amplification module and the convolution module of the upsampling module 1005, reference may be made to the related embodiments of the amplification module 401 and the convolution module 402 described above.

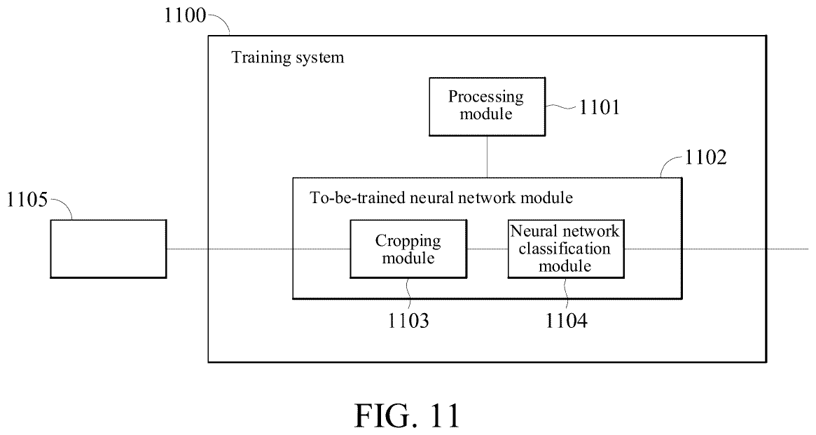

FIG. 11 is a block diagram of a training system according to some embodiments of the present invention. Refer to FIG. 11. A training system 1100 includes a processing module 1101 and a to-be-trained neural network module 1102. The to-be-trained neural network module 1102 includes a cropping module 1103 and a neural network classification module 1104. The cropping module 1103 is configured to receive an input training image 1105 and crop a duplicate image of the input training image 1105 to obtain a plurality of cropped images. The neural network classification module 1104 includes a plurality of training parameters. The neural network classification module 1104 is configured to generate an image quality classification corresponding to the input training image based on the foregoing cropped images.

Implementations of the cropping module 1103 and the neural network classification module 1104 are the same as those of the cropping module 601 and the neural network classification module 602 described above. Therefore, regarding the implementations of the cropping module 1103 and the neural network classification module 1104, reference may be made to the related embodiments of the cropping module 601 and the neural network classification module 602 described above.

The processing module 1101 is configured to train the to-be-trained neural network module 1102 by using a plurality of training images in a training set and an image quality classification label of each of the training images, to obtain a trained parameter value of each of the training parameters.

In some embodiments of the present invention, the trained parameter value of each training parameter obtained by the processing module 1101 is loaded into the neural network classification module 602, so that the neural network classification module 602 can generate the image quality classification of the film to which the image 104 belongs.

It is to be noted that the processing module 1001 and the processing module 1101 may be general-purpose processors, including a central processing unit (CPU) and a digital signal processor (DSP), an application specific integrated circuit (ASIC), a field-programmable gate array (FPGA), or other programmable logic devices.

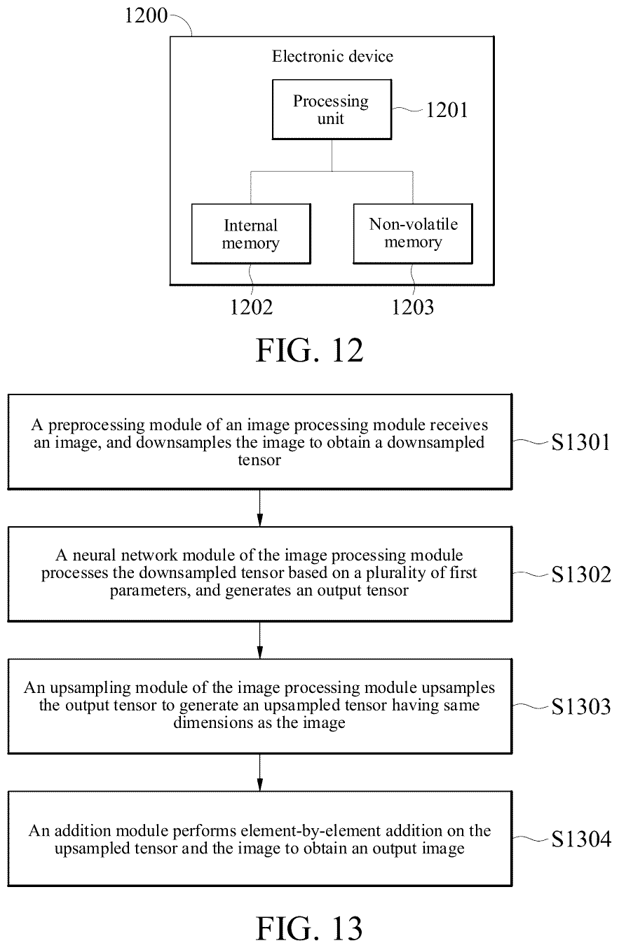

FIG. 12 is a schematic block diagram of an electronic device system according to some embodiments of the present invention. As shown in FIG. 12, at a hardware level, an electronic device 1200 includes a processing unit 1201, an internal memory 1202, and a non-volatile memory 1203. The internal memory 1202 is, for example, a RAM. The non-volatile memory 1203 is, for example, at least one disk memory. Certainly, the electronic device 1200 may also include hardware required for other functions.

The internal memory 1202 and the non-volatile memory 1203 are configured to store programs. The programs may include program code, and the program code includes computer operation instructions. The internal memory 1202 and the non-volatile memory 1203 provide instructions and data to the processing unit 1201. The processing unit 1201 reads the corresponding computer program from the non-volatile memory 1203 into the internal memory 1202 and then runs the computer program to form an image processing system 100 or 500 at a logical level.

The processing unit 1201 may be an integrated circuit chip having a signal processing capability. During implementation, the methods and steps disclosed in the foregoing embodiments may be completed through an integrated logic circuit of hardware in the processing unit 1201 or an instruction in a form of software. The processing unit 1201 may be a general-purpose processor, including a CPU, a DSP, an ASIC, an FPGA, or other programmable logic devices, and may implement or perform the methods and steps disclosed in the foregoing embodiments.

The embodiments of this specification also provide a computer-readable storage medium. The computer-readable storage medium stores at least one instruction. The at least one instruction, when executed by a processing unit 1201 of an electronic device 1200, enables the processing unit 1201 of the electronic device 1200 to perform the methods and steps disclosed in the foregoing embodiments.

An example of the computer storage medium includes, but is not limited to, a phase-change memory (PRAM), a static RAM (SRAM), a dynamic RAM (DRAM), another type of RAM (RAM), a read-only memory (ROM), an electrically erasable programmable ROM (EEPROM), a flash memory or other internal memory technologies, a compact disc ROM (CD-ROM), a digital versatile disc (DVD) or another optical storage, a magnetic tape cassette, a magnetic tape disk storage or another magnetic storage device, or any other non-transmission medium that may be configured to store information accessible by a computing device. According to the definition in this specification, the computer-readable medium does not include transitory media, such as modulated data signals and carrier waves.

The foregoing embodiments provide the image processing system, the image processing method, and the training system. In the image processing system, the image is downsampled by the preprocessing module, then processed at a low resolution, and finally added back to the original image. Therefore, input dimensions of the neural network module may be reduced. A reduction in the input dimensions of the neural network module may reduce an amount of computation, a buffer required by operation, and energy consumption of the neural network module at runtime, so that the neural network module may be designed as a neural network with a deep structure under the same operation resource to obtain a wider field of view. In addition, an image processing effect may be quickly obtained through the neural network by means of the parameter values trained by the neural network training system.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An image processing system, comprising:
an image processing module, comprising a preprocessing module, a neural network module, and an upsampling module, wherein the preprocessing module is configured to receive an image, and downsample the image to obtain a downsampled tensor, the neural network module is configured to process the downsampled tensor based on a plurality of first parameters, and generate an output tensor, and the upsampling module is configured to upsample the output tensor to generate an upsampled tensor having same dimensions as the image; and
an addition module, configured to perform element-by-element addition on the upsampled tensor and the image to obtain an output image.

2. The image processing system according to claim 1, wherein the preprocessing module performs pixel unshuffling on the image based on a zoom-out factor to downsample the image, and the downsampled tensor retains pixel information of the image.

3. The image processing system according to claim 1, wherein the upsampling module is configured to perform pixel shuffling on the output tensor based on a zoom-in factor to upsample the output tensor.

4. The image processing system according to claim 1, wherein the upsampling module comprises:
an amplification module, configured to amplify the output tensor to generate an amplified output tensor; and
a convolution module, comprising at least one convolutional layer, wherein the convolution module is configured to process the amplified output tensor based on a plurality of second parameters to generate the upsampled tensor.

5. The image processing system according to claim 1, wherein the image is a high-resolution image.

6. The image processing system according to claim 1, comprising an image quality detection module and a loading module, wherein the image quality detection module is configured to generate, based on the image, an index corresponding to an image quality classification of a film to which the image belongs, and the loading module is configured to obtain a plurality of image processing parameter values corresponding to the image quality classification from a memory module based on the index, and load the image processing parameter values into the image processing module.

7. The image processing system according to claim 6, wherein the image quality detection module comprises a cropping module, a neural network classification module, and a mapping module, the cropping module is configured to receive the image, and crop the image to obtain a plurality of cropped images, the neural network classification module is configured to generate, based on the cropped images, the image quality classification of the film to which the image belongs, and the mapping module is configured to generate the index based on the image quality classification.

8. The image processing system according to claim 1, wherein the neural network module comprises a plurality of residual network layers connected in series, and the residual network layers are configured to receive the downsampled tensor and generate the output tensor.

9. An image processing method, comprising:
(a) receiving, by a preprocessing module in an image processing module, an image, and downsampling the image to obtain a downsampled tensor;
(b) processing, by a neural network module in the image processing module based on a plurality of first parameters, the downsampled tensor, and generating an output tensor;
(c) upsampling, by an upsampling module in the image processing module, the output tensor to generate an upsampled tensor having same dimensions as the image; and
(d) performing, by an addition module, element-by-element addition on the upsampled tensor and the image to obtain an output image.

10. The image processing method according to claim 9, wherein step (a) comprises: performing, by the preprocessing module, pixel unshuffling on the image based on a zoom-out factor to downsample the image, wherein the downsampled tensor retains pixel information of the image.

11. The image processing method according to claim 9, wherein step (d) comprises: performing, by the upsampling module, pixel shuffling on the output tensor based on a zoom-in factor to upsample the output tensor.

12. The image processing method according to claim 9, wherein the upsampling module comprises an amplification module and a convolution module, the convolution module comprises at least one convolutional layer, and step (d) comprises:
amplifying, by the amplification module, the output tensor to generate an amplified output tensor; and
processing, by the convolution module, the amplified output tensor based on a plurality of second parameters to generate the upsampled tensor.

13. The image processing method according to claim 9, wherein the image is a high-resolution image.

14. The image processing method according to claim 9, wherein the image processing system comprises an image quality detection module and a loading module, and the image processing method comprises:
(e) generating, by the image quality detection module based on the image, an index corresponding to an image quality classification of a film to which the image belongs; and
(f) obtaining, by the loading module, a plurality of image processing parameter values corresponding to the image quality classification from a memory module based on the index, and loading the image processing parameter values into the image processing module.

15. The image processing method according to claim 14, wherein the image quality detection module comprises a cropping module, a neural network classification module, and a mapping module, and step (e) comprises:
receiving the image and cropping the image to obtain a plurality of cropped images by the cropping module;
generating, by the neural network classification module based on the cropped images, the image quality classification of the film to which the image belongs; and
generating, by the mapping module, the index based on the image quality classification.

16. The image processing method according to claim 9, wherein the neural network module comprises a plurality of residual network layers connected in series, and step (b) comprises: receiving the downsampled tensor and generating the output tensor by the residual network layers.

17. A training system, comprising a processing module and a to-be-trained image processing module, wherein the to-be-trained image processing module comprises:
a preprocessing module, configured to receive an input training image and downsample the input training image to obtain a downsampled tensor;
a neural network module, configured to process the downsampled tensor based on a plurality of first training parameters, and generate an output tensor;
an upsampling module, configured to upsample the output tensor to generate an upsampled tensor having same dimensions as the input training image; and
an addition module, configured to perform element-by-element addition on the upsampled tensor and the input training image to obtain an output training image, wherein
the processing module is configured to train the to-be-trained image processing module by using a plurality of training images in a training set and a plurality of target images corresponding to the training images, to obtain a trained parameter value of each of a plurality of image processing training parameters of the to-be-trained image processing module, and the image processing training parameters comprise the first training parameters.

18. The training system according to claim 17, wherein the upsampling module is configured to perform pixel shuffling on the output tensor based on a zoom-in factor to upsample the output tensor.

19. The training system according to claim 17, wherein the image processing training parameters comprise a plurality of second training parameters, and the upsampling module comprises:
an amplification module, configured to amplify the output tensor to generate an amplified output tensor; and
a convolution module, comprising at least one convolutional layer, wherein the convolution module is configured to process the amplified output tensor based on the second training parameters to generate the upsampled tensor.
